(19) United States
(12) Patent Application Publication
(10) Pub. No.: US 2007/0172720 A1
(43) Pub. Date: Jul. 26, 2007

(54) FUEL CELL UNIT

(75) Inventors: SATOSHI MOGI, YAMATO-SHI (JP); MASAAKI SHIBATA, TOKYO (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/616,632

(22) Filed: Dec. 27, 2006

(30) Foreign Application Priority Data
Jan. 23, 2006 (JP) 2006-014259

(51) Int. Cl. H01M 4/94; H01M 8/02

(52) U.S. Cl. 429/44; 429/38

(57) ABSTRACT

The present invention provides a fuel cell unit having a structure in which vapor is efficiently diffused in a fuel diffusion layer through a region having a reduced diffusion resistance, so that vapor is spread to every corner in a direction along an opening, thereby reducing variation in wetness of a polymer electrolyte membrane. As a result, as compared with a case where there is no region having a reduced diffusion resistance, a proper moistened state is maintained over a wider range of the polymer electrolyte membrane, thereby making it possible to enhance hydrogen ion transfer ability of the polymer electrolyte membrane as a whole.

### BACKGROUND OF THE INVENTION

1. Field of the Invention

The present invention relates to a fuel cell unit which effects reaction between hydrogen gas and oxygen in an atmosphere by using a polymer electrolyte membrane capable of moving hydrogen ions in a moistened state, and more specifically, to a technique for securing a proper moistened state throughout the polymer electrolyte membrane.

2. Related Background Art

A polymer electrolyte membrane moving hydrogen ions in a moistened state has been put into practical use, and there has been proposed a fuel cell which effects reaction between hydrogen gas and oxygen in the atmosphere by using a polymer electrolyte membrane. In a fuel cell of this type, fuel cell units each composed of a fuel diffusion layer arranged on one side of a polymer electrolyte membrane and an oxygen diffusion layer arranged on the other side of the membrane are stacked together, and a separator or the like is provided each between the fuel diffusion layer and the oxygen diffusion layer of the adjacent fuel cell units to shut off gas transfer.

U.S. Pat. No. 5,514,486 discloses a fuel cell device having a fuel cell unit in which a fuel diffusion layer is arranged on one side of a polymer electrolyte membrane and an oxygen diffusion layer is arranged on the other side of the membrane (see FIGS. 7A and 7B). Here, a hydrogen gas supply port is arranged at the center of the fuel cell unit, and a fuel diffusion layer, a polymer electrolyte membrane, an oxygen diffusion layer, a separator, etc. which are formed in a disc shape are stacked together.

When incorporating a fuel cell into a small electronic apparatus, it is necessary to design the fuel cell in conformity with an accommodation space and an inner structure of the apparatus. In order to operate the fuel cell, supply of atmospheric air and discharge of generated vapor are indispensable. However, there are considerable limitations regarding an atmospheric air supply port and a vapor discharge port of the fuel cell from the viewpoint of an artistic design and the inner structure of the apparatus.

When the limitations are imposed on the fuel cell from the viewpoint of the artistic design and the inner structure of the apparatus, it is impossible for the fuel cell to adopt an optimum selection in terms of a function of the fuel cell unit. On the other hand, in the fuel cell as disclosed by U.S. Pat. No. 5,514,486, the external appearance and structure of the fuel cell are optimized in favor of the fuel cell unit, but this disturbs the external appearance design and small-sized formation of the electronic apparatus.

For example, when a fuel cell of a parallelepiped external appearance is designed in conformity with the accommodation space of the apparatus, and the atmospheric air supply port and the vapor discharge port are provided at two opposing sides of a rectangular section, respectively, with avoiding arrangement of an electronic circuit, there occurs, as described below, a shortage of moisture at four corners of the rectangular polymer electrolyte membrane, which may disable the polymer electrolyte membrane to contribute to normal power generation.

### SUMMARY OF THE INVENTION

An object of the present invention is to provide a fuel cell in which variation in the moistened state over an entire surface of the polymer electrolyte membrane is reduced to thereby achieve improvement in power generation performance and starting performance.

In the fuel cell unit of the present invention, vapor is efficiently diffused in the fuel diffusion layer through a region having a reduced diffusion resistance, so that vapor is spread to every corner in a direction along the opening, thereby reducing the variation in wetness of the polymer electrolyte membrane. As a result, as compared with the case where there is no region having a reduced diffusion resistance, a proper moistened state is maintained over a wider range of the polymer electrolyte membrane, thereby making it possible to enhance the hydrogen ion moving performance of the polymer electrolyte membrane as a whole. It is possible to secure an efficient power generation state involving little variation over a wider range of the polymer electrolyte membrane.

In other words, by effecting slight changes in the fuel diffusion layer in correspondence with a planar configuration and opening arrangement thereof, it is possible to reduce the variation in the moistened state over the entire surface of the polymer electrolyte membrane as compared with a case where no change is effected. Further, it is possible to solve the problems in terms of function due to the limitations involved in the apparatus into which the fuel cell is to be incorporated.

According to an aspect of the present invention, there is provided a fuel cell unit comprising: a polymer electrolyte membrane; two catalyst layers provided opposite to each other through the polymer electrolyte membrane; a fuel diffusion layer provided in contact with one catalyst layer of the two catalyst layers; an oxygen diffusion layer provided in contact with the other catalyst layer of the two catalyst layers; and two openings, wherein the two openings are provided respectively in two side surfaces which exist parallel and opposite to a proton conductive direction of the polymer electrolyte membrane among side surfaces of the oxygen diffusion layer, wherein the fuel diffusion layer has at least a region having a fuel diffusion resistance of A and a region having a fuel diffusion resistance of B; the fuel diffusion layer has a symmetry point, the fuel diffusion resistance A is larger than the fuel diffusion resistance B; the region having the fuel diffusion resistance of B intersects a plane parallel to the openings and containing the symmetry point; and the region having a fuel diffusion resistance of B can contain a longest segment that is parallel to interfaces between the polymer electrolyte membrane and the catalyst layers and parallel to the openings is longer than a longest segment that can exist in the region having a fuel diffusion resistance of B and that is parallel to the interfaces between the polymer electrolyte membrane and the catalyst layers and perpendicular to the openings.

According to another aspect of the present invention, there is provided a fuel cell unit comprising: a polymer electrolyte membrane; two catalyst layers provided opposite to each other through the polymer electrolyte membrane; a fuel diffusion layer provided in contact with one catalyst layer of the two catalyst layers; an oxygen diffusion layer provided in contact with the other catalyst layer of the two catalyst layers; and one opening, wherein the opening is provided in a side surface which exists parallel to a proton conductive direction of the polymer electrolyte membrane among side surfaces of the oxygen diffusion layer, wherein the fuel diffusion layer has at least a region having a fuel diffusion resistance of A and a region having a fuel diffusion resistance of B, the fuel diffusion resistance A is larger than the fuel diffusion resistance B, the region having a fuel diffusion resistance of B exists in a vicinity of a region which is in point symmetry in the fuel diffusion layer with respect to a region in the fuel diffusion layer existing in the same plane as the openings, and the region having a fuel diffusion resistance of B can contain a longest segment that is parallel to interfaces between the polymer electrolyte membrane and the catalyst layers and parallel to the openings is longer than a segment perpendicular to the openings and parallel to the interfaces.

Further features of the present invention will become apparent from the following description of exemplary embodiments with reference to the attached drawings.

### BRIEF DESCRIPTION OF THE DRAWINGS

FIG. 1 is an explanatory view of a constitution of a small electronic apparatus into which a fuel cell according to an embodiment of the present invention is to be incorporated.

FIG. 2 is an explanatory vertical sectional view illustrating a structure of a fuel cell unit.

FIGS. 3A and 3B are explanatory horizontal sectional views of the fuel cell unit of FIG. 2.

FIGS. 4A and 4B are explanatory views illustrating hydrogen gas flow and oxygen flow in the fuel cell unit.

FIG. 5 is an explanatory view illustrating the state of electric power generation using a polymer electrolyte membrane.

FIG. 6 is a sectional view of a fuel cell unit of the air breathing fuel cell disclosed by U.S. Pat. No. 5,514,486.

FIGS. 7A and 7B are plan views of the fuel cell unit of FIG. 6.

FIGS. 8A and 8B are horizontal sectional views showing a structure of a fuel cell unit.

FIGS. 9A, 9B and 9C are a vertical sectional view and horizontal sectional views showing a structure of a fuel cell unit.

FIGS. 10A, 10B and 10C are a vertical sectional view and horizontal sectional views showing a structure of a fuel cell unit.

### DESCRIPTION OF THE EMBODIMENTS

In the following, a fuel cell using a fuel cell unit according to an embodiment of the present invention will be described in detail with reference to the drawings. The fuel cell unit of the present invention is not restricted to a fuel cell constitution described below but can also be realized in another embodiment in which the construction of a fuel cell unit 10 is replaced partially or entirely by some other constitution as long as the fuel cell adopts a polymer electrolyte membrane and is under limitations imposed by the apparatus into which it is to be incorporated.

The fuel cell of the present invention can be embodied in a form that is detachably attached to a portable small electronic apparatus, such as a digital camera, a digital video camera, a small projector, a small printer, or a notebook computer. It can also be embodied in a form that is inseparably incorporated into an electronic apparatus or the like and performs solely fuel supply from the outside.

The structure, the electric power generation cell material and assembly structure, the operating principle, the manufacturing method, the operating condition, etc. of the fuel cell device shown in U.S. Pat. No. 5,514,486 are considerably different from the gist of the present invention, so that they are shown only partially, and a detailed description of those will be omitted.

In the drawings showing the embodiments, reference numeral 10 indicates a fuel cell unit, reference numeral 11 indicates a polymer electrolyte membrane, reference symbol 12a indicates a fuel electrode, reference symbol 12b indicates an oxidizer electrode, reference numeral 13 indicates a fuel flow field plate (fuel diffusion layer), reference numeral 14 indicates an oxygen flow field plate (oxygen diffusion layer), reference numerals 15, 16, and 19 indicate seal members, reference numeral 17 indicates an insulating layer (separator plate), reference numeral 18 indicates a fuel flow path (supply port), reference numeral 20 indicates an opening (opening part), reference numeral 21 indicates a region having a reduced diffusion resistance, reference numeral 50 indicates a small electronic apparatus, reference numeral 51 indicates air introducing inlets (the vent holes), reference numeral 52 indicates a fuel cell, and reference numeral 53 indicates a fuel tank.

### First Embodiment

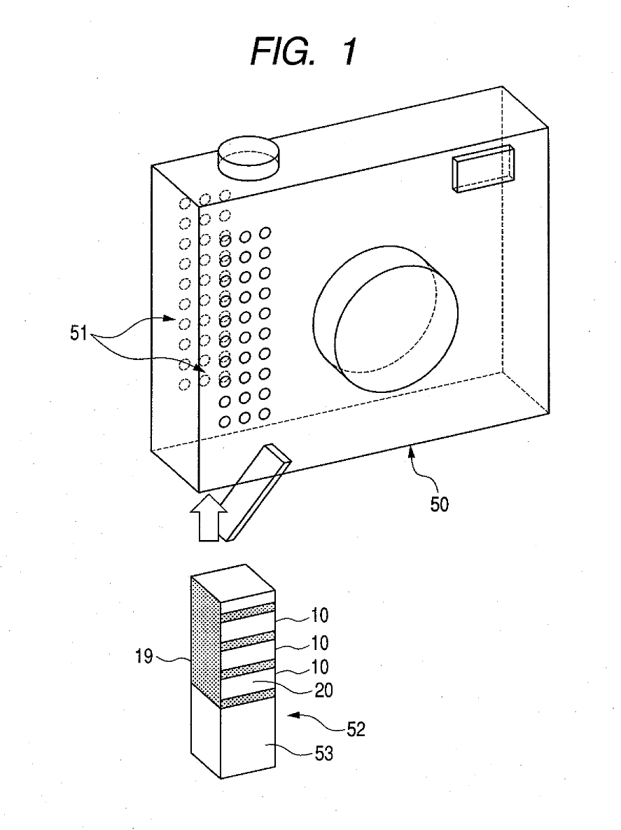

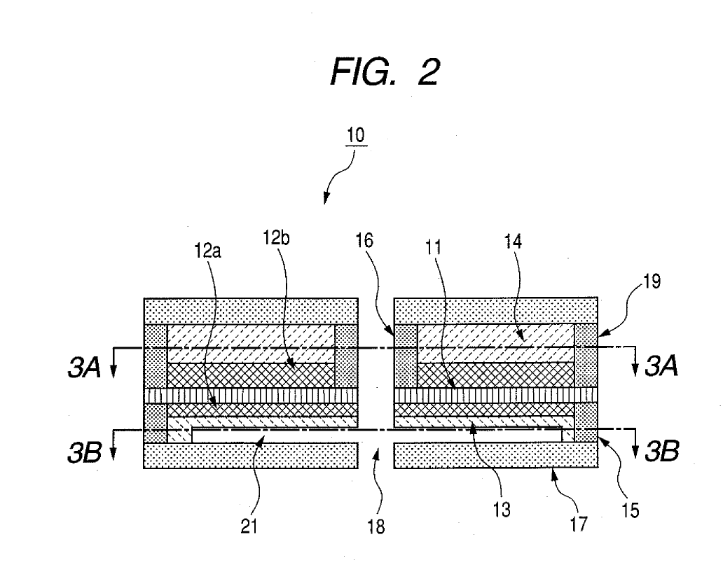

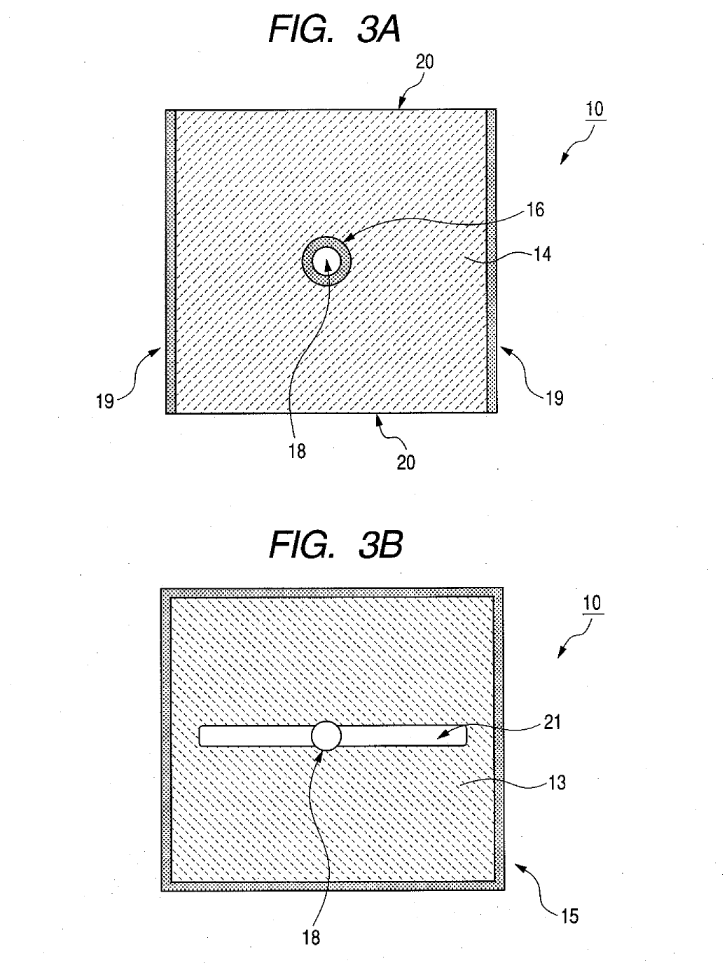

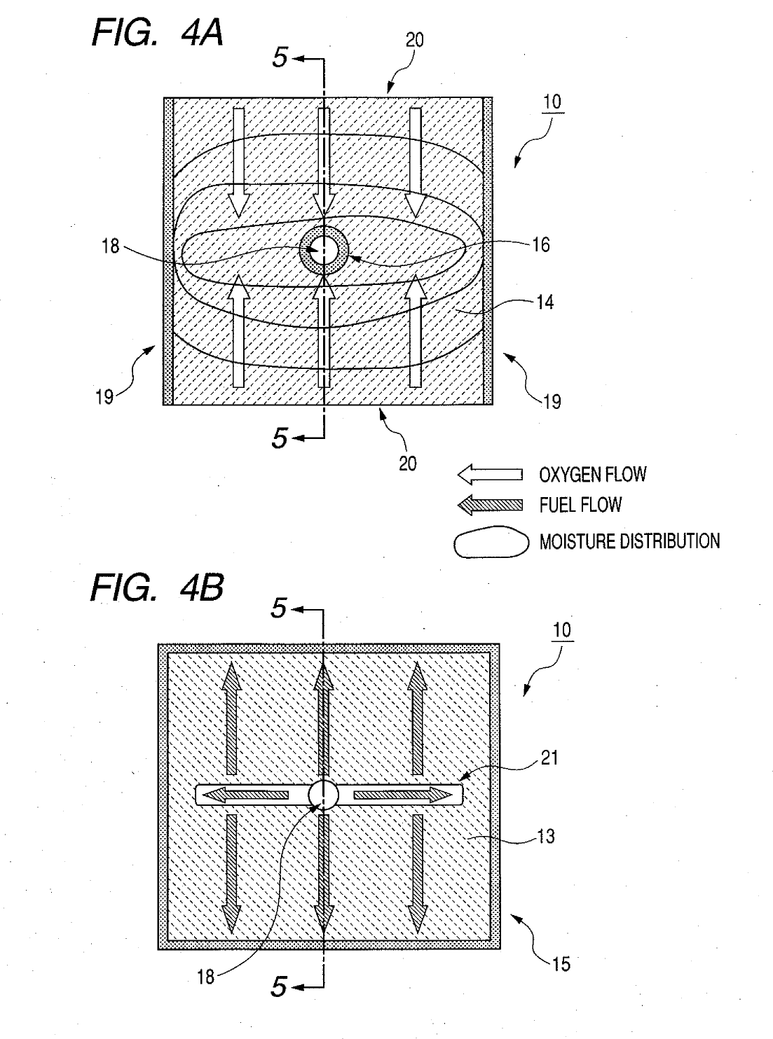

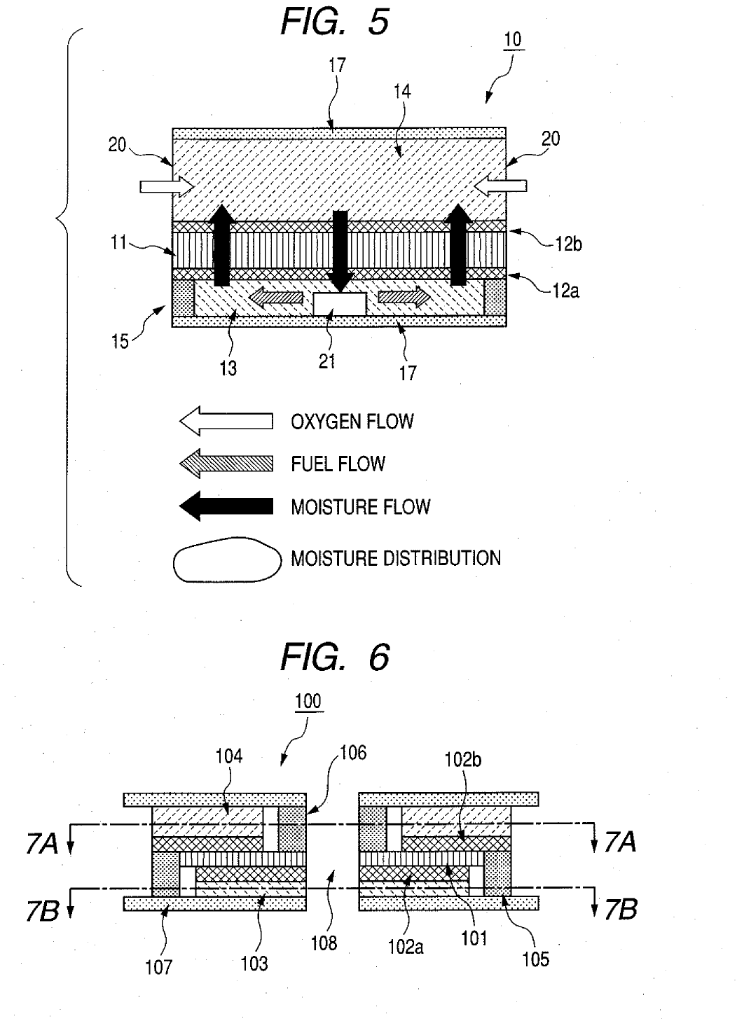

FIG. 1 is an explanatory view of a constitution of a small electronic apparatus to which a fuel cell according to a first embodiment of the present invention is incorporated; FIG. 2 is an explanatory vertical sectional view illustrating a structure of a fuel cell unit; and FIGS. 3A and 3B are explanatory horizontal sectional views of the fuel cell unit of FIG. 2. FIGS. 4A and 4B are explanatory views illustrating hydrogen gas flow and oxygen flow in the fuel cell unit; and FIG. 5 is an explanatory view illustrating the state of electric power generation using a polymer electrolyte membrane. FIGS. 3A and 4A are horizontal sectional view taken in the line 3A-3A of FIG. 2, and 3B and 4B are horizontal sectional view taken in the line 3B-3B of FIG. 2.

FIG. 1 is the explanatory view showing the constitution of the small electronic apparatus into which the fuel cell according to this embodiment is incorporated.

As shown in FIG. 1, the fuel cell 52 of this embodiment can be detachably incorporated into the small electronic apparatus (digital camera) 50. The fuel cell 52 is designed to have a parallelepiped external appearance in conformity with the accommodation space in the small electronic apparatus 50 in which a plurality of fuel cell units 10 are stacked together, and an endmost fuel cell unit is connected to the fuel tank 53. In this embodiment, the vent holes 51 are formed in a front surface and a back surface of the small electronic apparatus 50, and therefore openings 20 for introducing atmospheric air into the fuel cell units 10 are arranged in the fuel cell 52 at positions where the openings 20 overlap the vent holes 51. The openings 20 are arranged in the front surface and the back surface of the fuel cell 52, and the seal members 19 are arranged on right-hand and left-hand side surfaces of the fuel cell, so that the fuel cell units do not directly discharge vapor into an interior of the small electronic apparatus 50.

FIG. 2 is an explanatory vertical sectional view illustrating the structure of the fuel cell unit.

As shown in FIG. 2, one stage of the fuel cell unit 10 stacked on the separator plate 17 has the polymer electrolyte membrane 11, fuel electrode 12a, oxidizer electrode 12b, fuel flow field plate 13 and oxygen flow field plate 14. The fuel electrode 12a and the oxidizer electrode 12b are provided opposite to each other through the polymer electrolyte membrane 11.

In the present invention, on a basis of the polymer electrolyte membrane 11, the catalyst layer provided on the side of the fuel flow field plate is referred to as “fuel electrode”, and the catalyst layer provided on the side of the oxygen flow field plate is referred to as “oxidizer electrode”. In addition, the fuel flow field plate has a function of diffusing a fuel and therefore is hereinafter referred to as “fuel diffusion layer” in some cases. Similarly, the oxygen flow field plate has a function of diffusing an oxygen gas and therefore is hereinafter referred to as “oxygen diffusion layer” in some cases.

The fuel flow field plate 13 is arranged so as to be in contact with the fuel electrode 12a, and the oxygen flow field plate 14 is arranged so as to be in contact with the oxidizer electrode 12b. The fuel flow field plate 13 supplies hydrogen gas to the entire surface of the fuel electrode 12a. The oxygen flow field plate 14 supplies oxygen in the atmosphere to the entire surface of the oxidizer electrode 12b, and discharges vapor generated in the oxidizer electrode 12b to the exterior.

The fuel flow field plate 13 and the oxygen flow field plate 14 are formed of a conductive porous material. Such conductive porous material includes, for example, carbon papers, carbon clothes, and foamed metals. Each of the fuel flow field plate 13 and the oxygen flow field plate 14 may be formed as a single layer or a plurality of layers. In a case where the fuel flow field plate 13 or the oxygen flow field plate 14 is formed as a plurality of layers. Respective layers can be formed of materials having different porosities. For example, there is a case where a layer close to the catalyst layer is formed of a material having a relatively low porosity such as a carbon paper or a carbon cloth and a layer far from the catalyst layer is formed of a foamed metal. In the present embodiments, for example, as the conductive porous material, it is possible to use a porous metal plate manufactured by Mitsubishi Materials Corporation. In addition, in comparison with the fuel flow field plate 13 in which a hydrogen gas actively flows in one direction, the oxygen flow field plate 14 transfers oxygen and steam in both directions mainly by natural diffusion and is designed to have a large thickness. With respect to the sizes of the fuel flow field plate 13 and the oxygen flow field plate 14, for example, the thickness of the fuel flow field plate 13 can be set to 0.5 mm, and the oxygen flow field plate 14 can be set to 2 mm. For the same reason, the porosity of the fuel flow field plate 13 can be set to about 70%, and the porosity of the oxygen flow field plate 14 can be set to about 90%.

As shown in FIG. 3A, the hydrogen gas fuel flow path 18 is arranged at the center of the fuel cell unit 10, and the fuel flow path 18 extends through all the fuel cell units 10 of the fuel cell 52 (FIG. 1) to be connected to the fuel tank 53 (FIG. 1). As shown in FIG. 3B, the fuel flow path 18 guides hydrogen gas extracted from the fuel tank 53 to the fuel flow field plate 13 of each fuel cell unit 10.

In an outer periphery of the fuel flow field plate 13, there is arranged the seal member 15 of heat resistant rubber so as to be in intimate contact with the separator plate 17, thereby preventing leakage of hydrogen gas into the ambient atmosphere. As shown in FIG. 3A, at the center of the oxygen flow field plate 14, there is arranged the seal member 16 of heat resistant rubber so as to be in intimate contact with the separator plate 17, thereby preventing the hydrogen gas flowing through the fuel flow path 18 from leaking to the oxygen flow field plate 14.

On the right-hand and left-hand side surfaces of the oxygen flow field plate 14, there are provided the seal members 19 so that the vapor generated in the fuel cell unit may not be discharged into the interior of the small electronic apparatus 50. In side surfaces of the oxygen flow field plate 14 where no seal members 19 are arranged, there are formed the openings 20 for introducing oxygen existing in the atmosphere and discharging vapor into the atmosphere.

The polymer electrolyte membrane 11 shown in FIG. 2 is a film material, and the fuel electrode 12a and the oxidizer electrode 12b are formed, respectively, on both surfaces of the polymer electrolyte membrane 11. The polymer electrolyte membrane is formed of a polymer material having hydrogen ion conductivity. In this embodiment, for example, Nafion (trade name) membrane manufactured by DuPont Kabushiki Kaisha can be adopted. The fuel electrode 12a and the oxidizer electrode 12b which are the catalyst layers formed on the both surfaces of the polymer electrolyte membrane are formed of fine particles of platinum or the like, platinum fine particles carried on a carrier such as carbon, a microstructure of platinum having a dendritic shape, or the like.

The fuel diffusion layer has at least a region having a fuel diffusion resistance of A and a region having a fuel diffusion resistance of B, and the fuel diffusion layer has a symmetry point; the fuel diffusion resistance A is larger than the fuel diffusion resistance B; the region having a fuel diffusion resistance of B intersects a plane parallel to the openings and containing the symmetry point; and the longest segment that can exist in the region having a fuel diffusion resistance of B and that is parallel to the interfaces between the polymer electrolyte membrane and the catalyst layers and parallel to the openings is longer than the longest segment that can exist in the region having a fuel diffusion resistance of B and that is parallel to the interfaces between the polymer electrolyte membrane and the catalyst layers and perpendicular to the openings. In the present invention, fuel diffusion resistance indicates the degree of ease with which the fuel is diffused, and the region having a low fuel diffusion resistance is a region having a high fuel diffusion rate, that is, a region having a high diffusion rate in Fick's first law.

As shown, for example, in FIG. 3B, as a specific method for forming in the fuel diffusion layer a region having a relatively high fuel diffusion resistance and a region having a relatively low fuel diffusion resistance, there is formed in the fuel flow field plate 13 a groove 21 containing the symmetry point of the fuel flow field plate 13 and extending in a direction parallel to the openings 20. The region having a low fuel diffusion resistance intersects a plane parallel to the openings and containing the symmetry point of the fuel diffusion layer. Further, the region having a low fuel diffusion resistance exists in a direction parallel to the openings. That is, the longest segment that can exist in the region having a low fuel diffusion resistance and that is parallel to the interfaces between the polymer electrolyte membrane and the catalyst layers and parallel to the openings is longer than the longest segment that can exist in the region having a low fuel diffusion resistance and that is parallel to the interfaces between the polymer electrolyte membrane and the catalyst layers and perpendicular to the openings. The groove 21 is a recess in the fuel flow field plate 13, and preferably has a depth corresponding to 30% to 70% of the thickness of the fuel flow field plate 13. More preferably, the depth of the groove corresponds to 50% to 60% of the thickness of the fuel flow field plate 13. It is desirable for the region having a low fuel diffusion resistance to be at a distance of 5 mm or less from one surface of the fuel flow field plate sharing one end with the openings 20. Further, it is desirable for the region having a low fuel diffusion resistance to be at the same distance from a region within the fuel diffusion layer existing in the same plane as the openings and a region which is in point symmetry with the region within the fuel diffusion layer.

Further, in the fuel flow field plate 13, it is desirable for the diffusion resistance coefficient A to be 1.5 or more times the diffusion resistance coefficient B. The example of forming the groove in the fuel flow field plate 13 will be described below.

FIG. 4A schematically shows the oxygen flow in the oxygen flow field plate 14, and FIG. 4B schematically shows the fuel flow in the fuel flow field plate 13. FIG. 5 is an enlarged sectional view taken in the line 5-5 of FIGS. 4A and 4B, showing the respective flows of oxygen, fuel (hydrogen gas), and moisture (vapor) as indicated by arrows.

As indicated by the arrows in FIG. 4A, in the oxygen flow field plate 14, oxygen in the atmosphere undergoes natural diffusion from the openings 20 in the front and rear sides of the fuel cell unit 10 toward the center. In the catalyst layer arranged on the surface of the polymer electrolyte membrane 11 (FIG. 5), the oxygen reacts with the hydrogen ion supplied from the polymer electrolyte membrane 11 to produce water molecules. The water molecules produced are captured by the polymer electrolyte membrane 11 to bring the polymer electrolyte membrane 11 into a moistened state; surplus moisture undergoes natural diffusion toward the openings 20 as vapor, and is discharged to the exterior through the openings 20.

On the opposite surface of the polymer electrolyte membrane 11, the hydrogen gas to be ionized in the polymer electrolyte membrane 11 is supplied to the fuel flow field plate 13 from the fuel tank 53 (FIG. 1) through the fuel flow path 18. The hydrogen gas passes from the fuel flow path 18 through the groove 21 of the fuel flow field plate 13, which is a region having a low fuel diffusion resistance, and then flows along the openings 20 of the oxygen flow field plate 14, bringing the surface of the fuel flow field plate 13 having the groove 21 into a uniform pressure state.

After hydrogen gas passes through the groove 21, the hydrogen gas flows to the fuel flow field plate 13 having a diffusion resistance higher than that of the groove 21 to be diffused substantially uniformly with respect to the surface having the groove 21. That is, it forms flows as indicated by the arrows in FIG. 4B and is supplied in the direction of the openings 20.

In this way, by forming a shallow groove 21 in the surface of the fuel flow field plate 13 on the side opposite to the polymer electrolyte membrane 11, the hydrogen gas is caused to flow from the groove 21 toward the openings 20.

The present inventors have carefully studied the moisture distribution in the oxygen flow field plate 14 and reached the conclusion that the moisture distribution is as shown in FIG. 4A. That is, the moisture amount is small in the vicinity of the openings 20; the more spaced apart from the openings 20, the larger the moisture amount. This is assumed to be due to the fact that the amount of water evaporated to the exterior is larger in the vicinity of the openings 20, and that the water evaporation is reduced as the openings 20 are departed from the openings. In the present invention, the term “vicinity” means a distance of 5 mm or less.

Regarding the moisture transfer in the polymer electrolyte membrane 11, it is necessary to take into account an electroendosmosis phenomenon and a back diffusion phenomenon. As shown in FIG. 5, the electroendosmosis phenomenon is a phenomenon in which moisture is transferred from the fuel electrode 12a to the oxidizer electrode 12b with the transfer of hydrogen ions from the fuel electrode 12a toward the oxidizer electrode 12b; a transfer amount depends on a magnitude of a generated electric current. The back diffusion phenomenon is a phenomenon in which moisture is transferred from the oxidizer electrode 12b to the fuel electrode 12a according to a water content gradient in the polymer electrolyte membrane 11.

As shown in FIG. 4A, in the region parallel to the openings 20 and around the symmetry point in the section of the oxygen flow field plate 14, an amount of water generated is large, so that, in a portion of the polymer electrolyte membrane 11 near the groove 21, the water content gradient between the oxidizer electrode 12b and the fuel electrode 12a is steep due to a difference in moisture content between the dry hydrogen gas on the fuel electrode 12a side and the moistened atmosphere on the oxidizer electrode 12b side. Here, the portion of the polymer electrode membrane 11 near the groove 21 refers to the region of the polymer electrode membrane 11 opposed to the portion where the groove 12 exists. Thus, as shown in FIG. 5, near the oxygen flow field plate 14, the transfer of moisture due to back diffusion is predominant, and a water movement from the oxidizer electrode 12b to the fuel electrode 12a is generated, with the result that the hydrogen gas existing in the vicinity of the surface of the groove 21 is moistened. On the other hand, in the vicinity of the openings 20, the moisture amount is small as shown in FIG. 4A, so that, due to the difference in moisture content between the hydrogen gas in contact with the surface of the groove 21 on the fuel electrode 12a side and moistened and the atmosphere on the oxygen electrode 12b side with small moisture content, the amount of water permeating from the oxidizer 12b toward the fuel electrode 12a is reduced. Thus, as shown in FIG. 5, the moisture transfer due to electroendosmosis becomes predominant, and moisture is transferred from the fuel electrode 12a to the oxidizer electrode 12b to moisten the air.

In other words, as shown in FIG. 4A, in the oxygen flow field plate 14, the moisture amount is small in the vicinity of the openings 20, and large in the vicinity of the groove 21. As a result, as shown in FIG. 5, in the fuel flow field plate 13, the hydrogen gas is moistened in the vicinity of the groove 21, and the moistened hydrogen gas is transferred to the vicinity of the portions of the fuel flow field plate 13 intersecting the planes where the openings 20 exist, generating water in the portions of the oxygen flow field plate 14 in the vicinity of the openings 20 through the polymer electrode membrane 11, the fuel electrode 12a, and the oxidizer electrode 12. Thus, unbalance in the moisture distribution in the fuel cell unit 10 is suppressed, and a proper moistened state is maintained throughout the polymer electrolyte membrane 11 to thereby attain an electric power generation state of high power generation efficiency.

Even when electric power generation is started with a shortage of moisture in the entire polymer electrode membrane 11, the entire polymer electrode membrane 11 is quickly transferred to a proper moistened state to enhance the starting characteristics. By enhancing the output, the electroendosmosis phenomenon is enhanced, and even if more moisture is carried away to the oxidizer electrode 12b side, more moisture is vaporized from the groove 21, so that moisture is efficiently replenished throughout the polymer electrode membrane 11 through the fuel flow field plate 13. If there is no groove 21, condensation occurs at a position near the fuel flow path 18, and there is a fear of the hydrogen gas diffusion being hindered; due to the presence of the groove 21, moisture is efficiently generated in a direction along the groove 21, so that a region where hydrogen gas hardly reaches is not easily generated.

Thus, in the fuel cell unit 10 of this embodiment, even if there is no complicated or large-scale mechanism for moistening/water control, the fuel cell unit starts quickly, and a stable output can be obtained for a long period of time. In the fuel cell 52 of this embodiment, the groove 21 is provided in a portion of the fuel flow field plate 13 far from the openings 20 of the oxidizer flow field plate 14, whereby efficient moisture transfer in the fuel cell unit 10 is promoted. As a result, it is possible to provide a fuel cell 52 which is stable in terms of output, which is applicable as the power source for the small electronic apparatus 50 or the like.

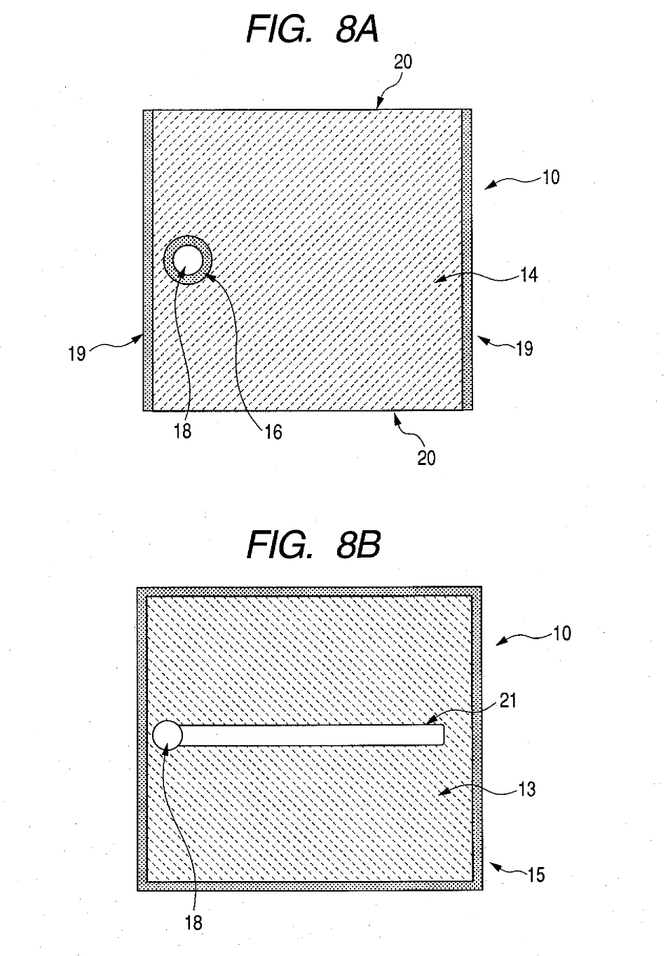

While in this embodiment, as described above, the fuel flow path 18 is formed in the vicinity of the symmetry point of the fuel flow field plate 13 as shown in FIG. 3, the same effect can also be obtained by forming, as shown in FIGS. 8A and 8B, a region having a low diffusion resistance in a region where the distances from the two openings are the same.

### Second Embodiment

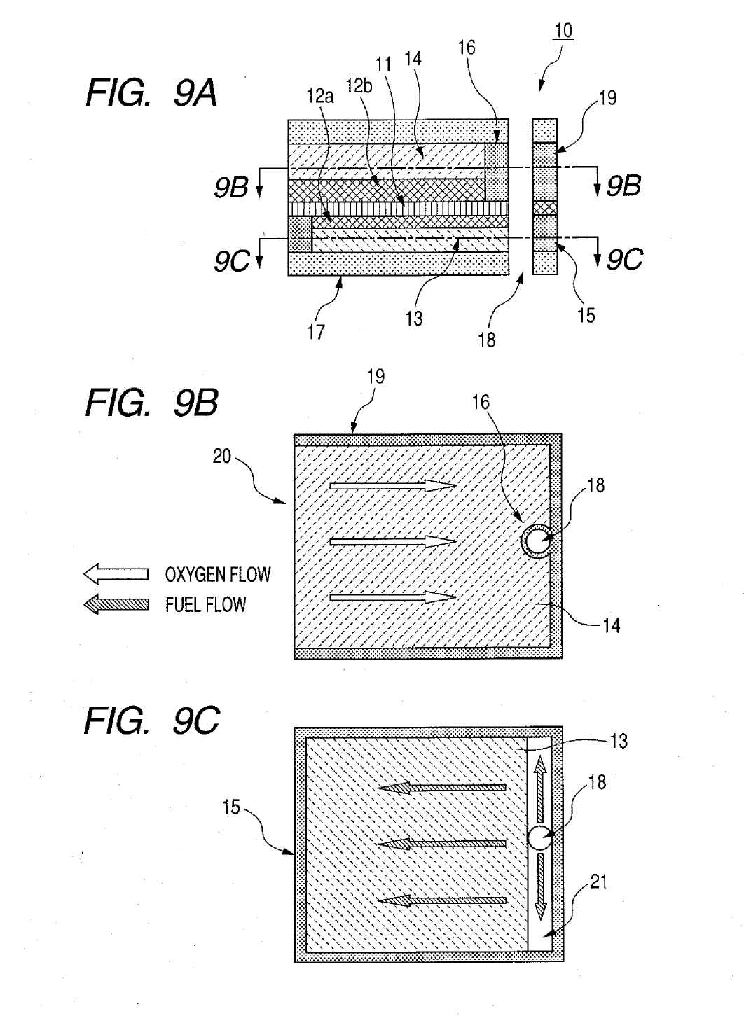

FIGS. 9A, 9B and 9C are sectional views of a fuel cell unit according to this embodiment. FIG. 9A is a sectional view taken in the same manner as in FIG. 2. FIGS. 9B and 9C are sectional views taken in the same manner as in FIGS. 3A and 3B.

As shown in FIGS. 9A, 9B and 9C, in this embodiment, the fuel cell unit has a single opening. In this embodiment, the region having a low fuel diffusion resistance is formed in the vicinity of a region which is in point symmetry in the fuel diffusion layer with respect to a region in the fuel diffusion layer existing in the same plane as the opening. Further, the longest segment that can exist in the region having a fuel diffusion resistance of B and that is parallel to the interface between the polymer electrode membrane and the catalyst layer and parallel to the opening is longer than the segment that is perpendicular to the opening and parallel to the interface.

When forming the groove 21 in the fuel flow field plate 13 as the region having a low fuel diffusion resistance in the same manner as in the first embodiment, the groove 21 is formed in a portion farthest from the opening 20 as shown in FIG. 9C.

As a result, a phenomenon similar to that in the first embodiment occurs. That is, in the vicinity of a position in point symmetry with respect to the portion of the oxygen flow field plate 14 in contact with the opening 20, the amount of water generated is large. The water generated in the vicinity of the position in point symmetry with respect to the portion in contact with the opening 20 is transferred through the polymer electrolyte membrane 11, the fuel electrode 12a, and the oxidizer electrode 12b to the vicinity of the region in the fuel flow field plate 13 existing in the same plane as the opening. Thus, the region having a low diffusion coefficient (groove 21) is formed in the portion of the fuel flow field plate 13 farthest from the opening 20 (in the vicinity of the region in the fuel flow path in point symmetry with respect to the region in the fuel flow path existing in the same plane as the opening).

As stated above, water travels from the oxidizer electrode through the polymer electrode membrane 11 to the region having a low diffusion coefficient, so that the amount of water generated is large. The hydrogen gas is transferred from the region of the fuel flow path where the diffusion coefficient is low (groove 21) to the region having a high diffusion coefficient (the other region thereof). That is, the hydrogen gas moistened in the region having a low diffusion coefficient (groove 21) is also spread to the region having a high diffusion coefficient, and the water spread to the region having a high diffusion coefficient travels to the portion of the oxygen flow field plate 14 near the opening 20 due to electroendosmosis. That is, the water permeates throughout the polymer electrolyte membrane 11.

Further, the fuel flow path 18 is preferably at a distance of 5 mm or less from the region having a low diffusion coefficient; more preferably, it is connected therewith. However, they may be spaced apart from each other if the difference in diffusion resistance of the fuel is large.

### Third Embodiment

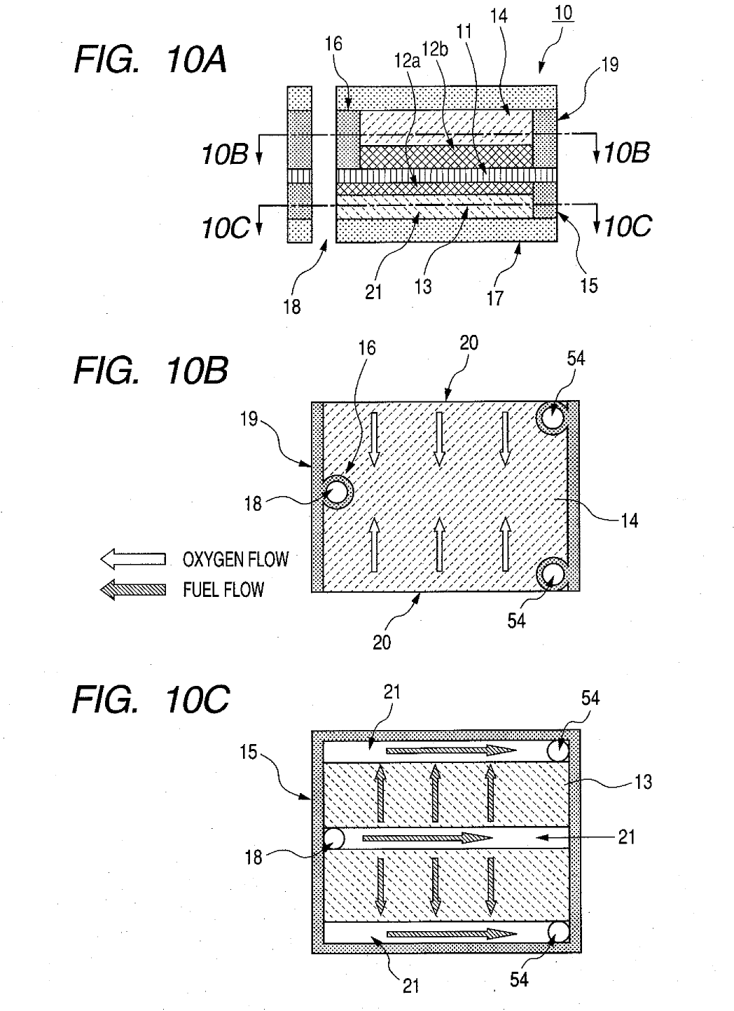

In this embodiment, each fuel flow field plate of the fuel cell unit stack has a fuel supply port for introducing fuel and fuel discharge ports for discharging fuel. As shown in FIGS. 10A, 10B and 10C, the fuel flow field plate 13 of this embodiment has a fuel supply port for discharging fuel from the fuel flow path 18 to the fuel flow field plate 13, and a fuel discharge port 54 for discharging fuel from the fuel flow field plate 13 to another fuel cell unit. As shown in FIGS. 10A, 10B and 10C, as in the first embodiment, water is likely to be generated in the region of the oxygen flow field plate 14 containing a symmetry point and parallel to the opening 20. In view of this, a region having a low diffusion coefficient is formed in the region of the fuel flow field plate 13 containing the symmetry point and parallel to the opening 20.

As shown in FIGS. 10A, 10B and 10C, it is desirable to form the fuel flow path 18 in the vicinity of one end of the region having a low diffusion resistance, and to form the fuel discharge port 54 in the vicinity of the other end thereof. Hydrogen gas enters the fuel flow field plate 13 through the fuel supply port of the fuel flow path 18, flows along the region having a low diffusion coefficient, and then is discharged into another fuel cell unit through the fuel discharge port 54. Here, after passing the region having a low diffusion resistance, the hydrogen gas diffuses from the region having a low diffusion resistance and a large water generation amount into the other region, and then is discharged through the fuel discharge port.

Thus, the effect of the present invention can be obtained also in the case where the fuel flow field plate 13 has the fuel supply port and the fuel discharge port 54 of the fuel flow path 18.

### FUEL CELL ACCORDING TO COMPARATIVE EXAMPLE

The fuel cell is capable of providing energy per unit volume in an amount several to about ten times that of a conventional secondary cell. Further, by filling the fuel cell with fuel, it allows a continuous long-time use of a small electronic apparatus, such as a mobile phone and a notebook computer, thus showing great promise.

A relatively large stationary power generation unit, an automotive mobile fuel cell, etc. are formed through combination of a cooling mechanism, a moistening/water-control mechanism, etc. However, in a fuel cell for small electronic apparatuses, due to the limitations in terms of cost, accommodation space, etc., it is desirable to adopt a constitution requiring no pressurization, cooling, moistening or the like and making it possible to obtain the necessary output with a simpler structure.

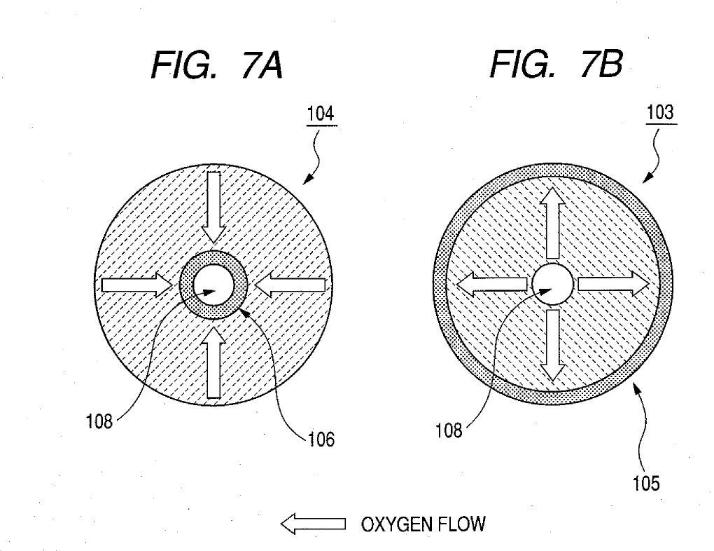

As such a fuel cell for small electronic apparatuses, U.S. Pat. No. 5,514,486 proposes an air breathing fuel cell which causes oxygen in the atmosphere to react with hydrogen gas by utilizing the natural diffusion of atmospheric air. FIG. 6 is a sectional view of a fuel cell unit of the air breathing fuel cell disclosed by U.S. Pat. No. 5,514,486, and FIGS. 7A and 7B are plan views of the fuel cell unit. FIG. 7A is a plan sectional view taken in the line 7A-7A of FIG. 6, and FIG. 7B is a plan sectional view taken in the line 7B-7B of FIG. 6.

As shown in FIG. 6, a fuel cell unit 100 has a membrane electrode assembly obtained by arranging the fuel electrode 102a and the oxidizer electrode 102b on the opposed surfaces of the polymer electrolyte membrane 101. Further, there are provided a fuel flow field plate 103 for supplying hydrogen gas to the fuel electrode 102a and an oxygen flow field plate 104 for supplying oxygen to the oxidizer electrode 102b.

In the outer periphery of the fuel flow field plate 103, there is provided a seal member 105 in intimate contact with separator plates 107, thus preventing hydrogen gas from being discharged to an ambience. In the inner periphery of the oxygen flow field plate 104, there is provided a seal member 106 in intimate contact with the separator plates 107, thus isolating the hydrogen gas flowing on the inner side of the seal member 106 from the oxygen flow field plate 104. The fuel flow field plate 103 and the oxygen flow field plate 104 are formed of a porous, electron-conductive material. A plurality of fuel cell units 100 can be stacked with interposition of the separator plates 107 which are impermeable to hydrogen gas and electrically conductive each between adjacent fuel cell units.

As indicated by the arrows in FIG. 7B, hydrogen gas passes through a fuel flow path 108 formed on the inner side of the seal member 106, and is supplied from the inner periphery of the fuel flow field plate 103; as shown in FIG. 6, the hydrogen gas is supplied along the surface of the membrane electrode assembly. As indicated by the arrows in FIG. 7A, oxygen in the atmosphere is supplied from the outer periphery of the oxygen flow field plate 104 through natural diffusion.

In this way, in the air breathing fuel cell, oxygen in the atmosphere is supplied to the membrane electrode assembly through natural diffusion, so that there is no need to provide a pressurization mechanism for supplying oxygen to the side of the oxygen flow field plate 104. Further, the oxygen supply is restricted depending on the diffusion rate, so that it is possible to suppress an excessive temperature rise in the fuel cell unit 100, thereby making it possible to omit or simplify the cooling mechanism. Further, the oxygen flow field plate 104 becomes the diffusion resistance of water to the exterior, so that it is possible to suppress drying of the moisture-containing polymer electrolyte membrane 101 adopted in the membrane electrode assembly. In the air breathing fuel cell, it is possible to omit the pressurization mechanism for supplying oxygen and means for cooling and moistening, thus providing a constitution suitable as the power source of a small electronic apparatus.

However, in a fuel cell for small electronic apparatuses, there are limitations from the viewpoint of the shape of the small electronic apparatus, the arrangement position of the power source, etc. Thus, as in the case of the small electronic apparatus 50 shown in FIG. 1, there are a case where it is rather difficult to use the annular fuel cell as disclosed in U.S. Pat. No. 5,514,486 and a case where there are limitations regarding the direction in which atmospheric air is introduced. When, under these restrictions, a fuel cell is used to generate electric power, a reduction in output may be involved.

The above problems have been solved by the fuel cell unit 10 of this embodiment; a plurality of fuel cell units 10 are stacked together to form a cell stack, realizing an air breathing type fuel cell 52 which is stable in terms of output. That is, in order to solve the problems, in the fuel cell unit 10, the fuel electrode 12a and the oxidizer electrode 12b are respectively arranged on the opposing surfaces of the polymer electrolyte membrane 11. There are arranged the fuel flow field plate 13 for supplying hydrogen gas to the fuel electrode 12a through diffusion, and the oxidizer flow field plate 14 for supplying oxygen to the oxidizer electrode 12b through diffusion. The oxidizer flow field plate 14 is open to the atmosphere through the openings 20. Further, in the fuel flow field plate 13, the groove 21 is formed at a position far from the openings 20, so that moisture is transferred efficiently in the fuel cell unit 10, whereby it is possible to provide a fuel cell 52 which is stable in terms of output.

(Correspondence with the Invention)

The fuel cell unit 10 of this embodiment includes: a fuel electrode 12a provided in contact with one face of a polymer electrolyte membrane 11 which transfers hydrogen ions in a moistened state; a fuel flow field plate 13, provided in contact with the fuel electrode 12a, which diffuses a hydrogen gas to the whole surface of the polymer electrolyte membrane 11; an oxidizer electrode 12b provided in contact with the other face of the polymer electrolyte membrane 11; and an oxidizer flow field plate 14, provided in contact with the oxidizer electrode 12b, which diffuses air introduced from an opening 20 in a side surface thereof to the whole surface of the polymer electrolyte membrane 11. In the groove 21 spaced apart from the openings 20 and extending along the openings 20, the diffusion resistance of the fuel flow field plate 13 is lower than that in the other region.

In the fuel cell unit 10, vapor is efficiently diffused in the fuel flow field plate 13 through the groove 21 having a low diffusion resistance, so that vapor is spread to every corner in the direction along the openings 20, thereby reducing the variation in the wetness of the membrane electrode assembly. As a result, as compared with the case where there is no groove 21 having a low diffusion resistance, a proper moistened state is maintained over a wider range of the membrane electrode assembly, thereby making it possible to enhance the hydrogen ion moving performance of the membrane electrode assembly as a whole. It is possible to secure an efficient power generation state involving little variation over a wider range of the membrane electrode assembly.

In other words, in the fuel flow field plate 13, a region having a low diffusion resistance is formed in correspondence with the positions of the openings, whereby it is possible to reduce the variation in the moistened state throughout the membrane electrode assembly composed of the polymer electrolyte membrane 11 and the fuel electrode 12a and oxidizer electrode 12b. That is, it is possible to obtain a fuel cell which makes it possible to suppress a reduction in output even in a case where the opening is formed only at a specified position due to the limitations involved in the apparatus into which the fuel cell is to be incorporated.

The groove 21 in the fuel cell unit 10 having a low diffusion resistance is situated at a position farthest from each of one or more openings 20.

The fuel flow field plate 13 and the oxygen flow field plate 14 of the fuel cell unit 10 have substantially the same plan shape in a section taken along a plane perpendicular to the direction in which hydrogen ions are conducted. Examples of the plan shape include a circular shape, a square shape, and a rectangular shape. In the case of a square or rectangular plan shape, the opening 20 is arranged at a portion corresponding to two opposing sides or one side in the plan shape. In the case where the opening 20 exists at a portion corresponding to two sides, it is desirable to form a region (groove 21) where the diffusion coefficient is low in a region at the same distance from the opposing two sides and parallel to the openings 20. In the case where the opening 20 exists only at a portion corresponding to one side, a region having a low diffusion resistance is provided in the vicinity of the other of two opposing sides. Similarly, in the case of a circular shape, when two opposing openings exist in the section of the fuel cell unit, there exists a region having a low diffusion resistance in the vicinity of the center of the circular shape; when only one opening exists, there is provided a region having a low diffusion coefficient in the vicinity of a region in the section in point symmetry with respect to the opening.

The supply port for supplying hydrogen gas to the fuel flow field plate 13 of the fuel cell unit 10 is connected to the groove 21 which is the region having a low diffusion resistance.

The fuel cell unit 10 is equipped with the membrane electrode assembly composed of the polymer electrolyte membrane 11 and the fuel electrode 12a and oxidizer electrode 12b respectively formed on both surfaces of the polymer electrolyte membrane 11, the fuel flow field plate 13 arranged on one side of the membrane electrode assembly, and the oxygen flow field plate 14 arranged on the other side of the membrane electrode assembly, wherein the fuel flow field plate 13 supplies hydrogen gas to the one surface for diffusion, and the oxygen flow field plate 14 introduces oxygen gas in the atmosphere from the openings 20 arranged in the side surfaces and supplies oxygen gas to the other surface through diffusion. Further, there is formed, in the fuel flow field plate 13, a region (groove 21) where hydrogen gas diffusion resistance is lower than in the other portion of the fuel flow field plate 13 extending along the openings 20. The groove 21 is formed in the fuel flow field plate 13 so as to include a region in the fuel flow field plate opposed to a region where more moisture stays than that in the periphery of the oxygen flow field plate 14 during power generation.

In other words, the groove 21 is formed in the fuel flow field plate 13 so as to include a region of the fuel flow field plate 13 opposed to the region of the oxygen flow field plate 14 where moisture stays the most when there is no groove 21, that is, the region where it is hardest for moisture to escape through the openings 20.

The groove 21 is arranged on the surface on the side opposite to the side where the fuel flow field plate 13 discharges hydrogen gas to the membrane electrode assembly, and does not reach the surface on the side of the membrane electrode assembly where hydrogen gas is discharged.

The groove 21 reaches neither of the side surfaces extending along the openings 20 of the fuel flow field plate 13. Thus, hydrogen gas is not directly escapes from the groove 21 to the gaps between the side surfaces of the fuel flow field plate 13 and the seal members 15. The hydrogen gas on the surface of the groove 21 is kept in a uniform pressure state, thereby stabilizing the permeance/diffusion of hydrogen gas in each portion of the surface of the groove 21.

The fuel cell 52 is formed by stacking together a plurality of fuel cell units 10, wherein the fuel flow field plate 13 of each fuel cell unit 10 and the oxygen flow field plates 14 of a fuel cell unit 10 adjacent to the each fuel cell unit 10 are interposed with the separators 17 which shields mutual transfer of gas. The entire side surfaces of the oxygen flow field plates 14 partitioned in the stacking direction by the separators 17 constitute the openings 20 for introducing atmospheric air.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-014259, filed Jan. 23, 2006, which is hereby incorporated by reference herein in its entirety.

What is claimed is:

1. A fuel cell unit comprising:
a polymer electrolyte membrane;
two catalyst layers provided opposite to each other through the polymer electrolyte membrane;
a fuel diffusion layer provided in contact with one catalyst layer of the two catalyst layers;
an oxygen diffusion layer provided in contact with the other catalyst layer of the two catalyst layers; and
two openings,
wherein the two openings are provided respectively in two side surfaces which exist parallel and opposite to a proton conductive direction of the polymer electrolyte membrane among side surfaces of the oxygen diffusion layer,
wherein the fuel diffusion layer has at least a region having a fuel diffusion resistance of A and a region having a fuel diffusion resistance of B,
wherein the fuel diffusion layer has a symmetry point,
wherein the fuel diffusion resistance A is larger than the fuel diffusion resistance B,
wherein the region having a fuel diffusion resistance of B intersects a plane parallel to the openings and containing the symmetry point, and
wherein the region having a fuel diffusion resistance of B can contain a longest segment that is parallel to interfaces between the polymer electrolyte membrane and the catalyst layers and parallel to the openings is longer than a longest segment that can exist in the region having a fuel diffusion resistance of B and that is parallel to the interfaces between the polymer electrolyte membrane and the catalyst layers and perpendicular to the openings.

2. A fuel cell unit comprising:
a polymer electrolyte membrane;
two catalyst layers provided opposite to each other through the polymer electrolyte membrane;
a fuel diffusion layer provided in contact with one catalyst layer of the two catalyst layers;
an oxygen diffusion layer provided in contact with the other catalyst layer of the two catalyst layers; and
one opening,
wherein the opening is provided in a side surface which exists parallel to a proton conductive direction of the polymer electrolyte membrane among side surfaces of the oxygen diffusion layer,
wherein the fuel diffusion layer has at least a region having a fuel diffusion resistance of A and a region having a fuel diffusion resistance of B,
wherein the fuel diffusion resistance A is larger than the fuel diffusion resistance B,
wherein the region having a fuel diffusion resistance of B exists in a vicinity of a region which is in point symmetry in the fuel diffusion layer with respect to a region in the fuel diffusion layer existing in the same plane as the openings, and
wherein the region having a fuel diffusion resistance of B can contain a longest segment that is parallel to interfaces between the polymer electrolyte membrane and the catalyst layers and parallel to the openings is longer than a segment perpendicular to the openings and parallel to the interfaces.

3. A fuel cell unit according to claim 1 or 2, wherein the fuel diffusion layer has a fuel supply port, and wherein the region having a fuel diffusion resistance of B and the fuel supply port are spaced apart from each other by a distance of 5 mm or less.

4. A fuel cell unit according to claim 3, wherein the fuel supply port is connected with the region having a fuel diffusion resistance of B.

5. A fuel cell unit according to claim 4, wherein the fuel diffusion layer has a fuel discharge port, and wherein the fuel discharge port is connected with the region having a fuel diffusion resistance of B.

6. A fuel cell unit according to claim 1 or 2, wherein the region having a fuel diffusion resistance of B is formed by a groove provided in the fuel diffusion layer.
